(19) United States
(12) Patent Application Publication
(10) Pub. No.: US 2014/0156988 A1
(43) Pub. Date: Jun. 5, 2014

(54) MEDICAL EMERGENCY-RESPONSE DATA MANAGEMENT MECHANISM ON WIDE-AREA DISTRIBUTED MEDICAL INFORMATION NETWORK

(71) Applicant: International Business Machines Corporation, Armonk, NY (US)

(72) Inventors: NOBUAKI TAKAHASHI, TOKYO (JP); GAKU YAMAMOTO, TOKYO (JP)

(73) Assignee: INTERNATIONAL BUSINESS MACHINES CORPORATION, Armonk, NY (US)

(21) Appl. No.: 14/081,496

(22) Filed: Nov. 15, 2013

(30) Foreign Application Priority Data
Nov. 30, 2012 (JP) 2012-262835

(51) Int. Cl. H04L 9/32

(52) U.S. Cl. CPC H04L 9/321
USPC 713/155

(57) ABSTRACT

A method, system, and/or computer program product provides medical information on a communication network. Encrypted medical information in a decryption request is received from a first computer connected to the communication network at a second computer, the second computer holding decryption information. The second computer determines whether or not the second computer holds decryption information for decrypting the encrypted medical information. In response to the second computer determining that the second computer holds the decryption information, the second computer checks with a third computer as to whether the first computer is authenticated. In response to the first computer being authenticated, the second computer: acquires the encryption information from the third computer; decrypts the encrypted medical information to create decrypted medical information; encrypts the decrypted medical information to create encrypted decrypted medical information; and sends the encrypted decrypted medical information to a sender that has sent the encrypted medical information.

This application is based on and claims the benefit of priority from Japan (JP) Patent Application No. 2012-262835, filed on Nov. 30, 2012, and herein incorporated by reference in its entirety.

### BACKGROUND

The present invention relates to management of medical information on a communication network and, in particular, to a method, system and computer program for distributing and managing medical information on a communication network over a wide area and securely and reliably providing medical information in the event of an emergency.

The importance of sharing electronic medical records among medical institutions has been recognized and such sharing has been actually implemented in some local communities and medical institutions. Standardization of the data formats of electronic medical records is being facilitated and the foundation to enable sharing electronic medical records is being laid. From a practical point of view, however, sharing of electronic records has not been widespread. This is because building a system that manages electronic medical records costs a large amount of money.

### SUMMARY

In one embodiment of the present invention, a method and/or computer program product provides medical information on a communication network. Encrypted medical information in a decryption request is received from a first computer connected to the communication network at a second computer, the second computer being connected to the communication network and holding decryption information. The second computer determines whether or not the second computer holds decryption information for decrypting the encrypted medical information. In response to the second computer determining that the second computer holds the decryption information, the second computer checks with a third computer as to whether the first computer is authenticated. In response to the first computer being authenticated, the second computer: acquires the encryption information for the first computer from the third computer; decrypts the encrypted medical information by using the decryption information to create decrypted medical information; encrypts the decrypted medical information by using the encryption information to create encrypted decrypted medical information; and sends the encrypted decrypted medical information to a sender that has sent the encrypted medical information.

In one embodiment of the present invention, a system provides medical information on a communication network. The system comprises: a first computer being connected to the communication network and issuing a request for decrypting encrypted medical information; a third computer being connected to the communication network and performing authentication of the first computer and registration of encryption information for the first computer; and a second computer connected to the communication network, the second computer comprising: a decryption information holding section holding decryption information; a receiving section for receiving encrypted medical information in a decryption request from the first computer; a determination section for determining whether or not decryption information for decrypting the encrypted medical information is held in the decryption information holding section; an authentication check section for, when the determination section determines that the decryption information is held, checking with the third computer whether or not the first computer is authenticated and, when the first computer is authenticated, acquiring the encryption information for the first computer from the third computer; a decryption section for decrypting the encrypted medical information by using the decryption information held in the decryption information holding section; an encryption section for using the encryption information acquired by the authentication check section to encrypt the medical information decrypted by the decryption section; and a sending section for sending the decrypted medical information encrypted by the encryption section to a sender that has sent the encrypted medical information.

### BRIEF DESCRIPTION OF THE SEVERAL VIEWS OF THE DRAWINGS

FIG. 1 a schematic configuration diagram of a wide-area distributed medical information network system 100 according to one embodiment of the present invention;

FIG. 2 is a diagram schematically illustrating an example of information registered and held in a medical data decryption computer 170;

FIG. 3 is a schematic flowchart of a process performed by a medical data decryption computer 170;

FIG. 4 is a schematic diagram illustrating a structure of an electronic message sent from a medical data browsing and updating computer 150 to a medical data decryption computer 170;

FIG. 5 is a schematic diagram illustrating a structure of an electronic message sent from a medical data decryption computer 170 to another medical data decryption computer 170;

FIG. 6 is a diagram schematically illustrating a basic hardware configuration of a medical data decryption computer 170;

FIG. 7 is a diagram schematically illustrating functional blocks of a medical data decryption computer 170; and

FIG. 8 is a diagram schematically illustrating an exemplary flow of data on a communication network during decryption of encrypted medical data.

### DETAILED DESCRIPTION

The best mode for carrying out the present invention will be described below in detail with respect to drawings. However, the embodiment described below is not intended to limit the present invention which is defined in the claims and not all combinations of features described in the embodiment are essential to the inventive solution. The present invention can be carried out in many different modes and should not be interpreted as being limited to the specifics in the descriptions of the embodiment. Throughout the description of the embodiment, like components or elements are given like reference numerals.

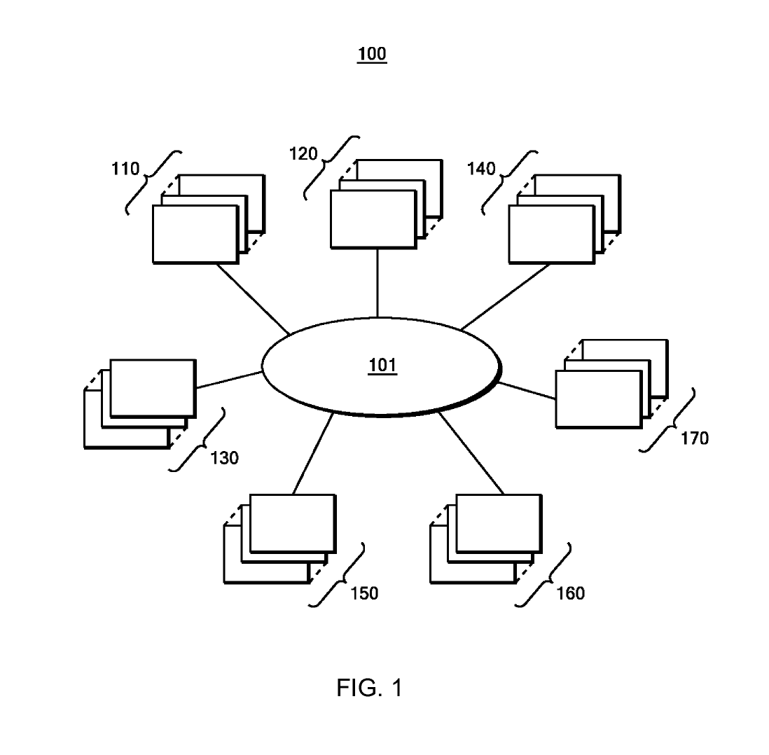

FIG. 1 schematically illustrates a configuration of a wide-area distributed medical information network system 100 according to one embodiment of the present invention. The network system 100 includes one or more medical data management computers 110, one or more medical data management replica computers 120, one or more medical data address management computers 130, one or more medical data temporary storage computers 140, one or more medical data browsing and updating computers 150, which correspond to a first computer, one or more medical institution authentication computers 160, which correspond to a third computer, and one or more medical data decryption computers 170, which correspond to a second computer, all of which are connected to a communication network 101, such as the Internet.

Medical Data Management Computer 110 is a master computer that stores patients' medical data, such as electronic medical records. The medical data management computer 110 stores encrypted medical data along with identification information (ID) of patients. For a plurality of patients, a plurality of pieces of identification information and encrypted medical data are stored. The medical data management computer 110 includes the function of encrypting medical data of interest and sending the encrypted medical data in response to a reference request from an external requester by externally accessing with identification information of a patient and the function of receiving updated encrypted medical data, decrypting and storing the data in response to an update request from an external requester. The medical data management computer 110 also includes the function of combining updated portions of data held in a plurality of update requests to generate up-to-data medical data when the medical data management computer 110 receives the plurality of update requests. Furthermore, the medical data management computer 110 provides updated latest medical data to a medical data management replica computer 120. Medical data has medical data address information, which includes identification information of a patient and address information of the computer that manages the medical data, for example the medical data management computer 110 or the medical data management replica computer 120. Encrypted medical data can be decrypted by a person who has decryption information, which is key information such as a secret key for decrypting the encrypted medical data, such as a person concerned, for example the patient, and can be accessed and updated by the person concerned. The medical data management computer 110 may be a personal computer at the home of a patient themselves, a server computer at a medical institution, or a server computer of a service provider that provides medical data management services.

The medical data management replica computer 120 includes the function of holding replicas, that is, copies, of patients' medical data stored in the medical data management computer 110 and sending medical data of interest in response to a reference request from an external requester, and the function of receiving and storing updated medical data in response to an update request from an external requester. The medical data management replica computer 120 may be a personal computer at the home of a relative or a friend of a patient, a server computer at a medical institution, or a server computer of a service provider that provides medical data management services.

The medical data address management computer 130 holds address information of medical data management computers 110 and medical data management replica computers 120 on which medical data of patients identified by identification information of the patients are stored. The medical data address management computer 130 has the function of recording identification information of a patient and address information of the medical data management computer 110 and the medical data management replica computer 120 when receiving an address registration request from an external requester. The medical data address management computer 130 also holds address information of another medical data address management computer 130. The medical data address management computer 130 has the function of returning address information of the medical data management computer 110 or medical data management replica computer 120 identified by identification information of a patient specified in an address request in response to the address request from an external requester. The medical data address management computer 130 has the function of, if there is not address information of a patient specified in a request, sending a request for address information of a computer that manages medical data to another medical data address management computer 130 using held address information along with the identification information of the patient and returning the acquired address information of the computer that manages the medical data to the requester. Patients or other parties can register address information of the medical data management computer 110 and the medical data management replica computer 120 that store medical data in a plurality of medical data address management computers 130 so that address information thus registered can be efficiently acquired. The computer may be a server computer at a medical institution or a server computer of a service provider providing medical data management services, for example.

Medical Data Temporary Storage Computer 140 is a computer temporarily storing updated medical data. When receiving updated encrypted medical data and data about the medical data management computer 110 or the medical data management replica computer 120 that stores the medical data from an external source, the medical data temporary storage computer 140 temporarily stores the data. For encrypted medical data stored in the medical data temporary storage computer 140, the medical data temporary storage computer 140 sends a medical data update request to a relevant medical data management computer 110 or a relevant medical data management replica computer 120 at regular intervals. The temporarily stored encrypted medical data is held until all of the medical data management computers 110 or medical data management replica computers 120 to which the data has been sent complete reception of the medical data. The computer may be a server computer of a medical institution or a server computer of a service provider providing medical data management services, for example.

Medical Data Browsing and Updating Computer 150 is a computer for browsing and updating medical data, for example a computer used by a doctor. The medical data browsing and updating computer 150 is configured to be able to send a request for address information of a computer that manages medical data to one or medical data address management computers 130 along with identification information of a patient. When a user (for example a doctor or a nurse) inputs identification information of a patient, the medical data browsing and updating computer 150 acquires address information of the medical data management computer 110 or medical data management replica computer 120 that manages medical data of that patient from a medical data address management computer 130 and sends a medical data request to a relevant one of the computers. When receiving encrypted medical data as a reply to the sent request, the user inputs key information, for example, that constitutes decryption information for decrypting the encrypted medical data to decrypt the encrypted medical data. Here, the key information for decryption may be a personal identification number or a password, for example, which may be recorded on an IC card or the like in some cases. When the user has updated medical data, the user inputs key information, for example, for encrypting the medical data to encrypt the medical data and sends the encrypted medical data to the medical data management computer 110 or the medical data management replica computer 120 or a medical data temporary storage computer 140 in association with the identification information of the patient. The medial data browsing and updating computer 150 may be a terminal computer used by a doctor or a nurse at a medical institution, for example.

Medical Institution Authentication Computer 160 is a computer for authenticating medical data browsing and updating computers 150. The medical data browsing and updating computers 150 at medical institution register encryption information, for example public key information, in the medical institution authentication computer 160 in advance. Before registration, the institution that owns the medical institution authentication computer 160 adequately investigates whether the registered medical institution is a qualified institution and registers only medical institutions judged qualified. Furthermore, in response to a request for authentication of a medical institution from a medical data decryption computer 170, which will be described below, the medical institution authentication computer 160 returns registered public key information if that medical institution is registered. On account of being an authentication institution, the medical institution authentication computers 160 are smaller in number than the other types of computers in the network system 100 but there may be more than one medical institution authentication computer 160 in the network system 100.

Medical Data Decryption Computer 170 is a computer that manages decryption information, for example key information such as secret keys, for decrypting patients' encrypted medical data. Each patient registers key information for decrypting his/her encrypted medical data in one or more medical data decryption computers in advance. The medical data decryption computer 170 receives a decryption request including encrypted medical data of a patient from a medical data browsing and updating computer 150, acquires encryption information, for example public key information, for the medical data browsing and updating computer 150 from a medical institution authentication computer 160, decrypts the encrypted medical information with key information that the medical data decryption computer 170 holds for decryption for the patient, writes information indicating that the encrypted medical data has been decrypted in response to the decryption request from the medical data browsing and updating computer 150 that sent the request in the medical data, encrypts the medical data with the public key information of the medical data browsing and updating computer 150, and sends the encrypted medical data to the medical data browsing and updating computer 150. If there is not registered key information of the patient, the medical data decryption computer 170 forwards the decryption request including identification information of the medical data browsing and updating computer 150, address information of the medical institution authentication computer 160, and identification information of the patient to a different medical data decryption computer 170. The different medical data decryption computer 170 receives the forwarded request and, if the registered key information exists in the medical data decryption computer 170, acquires the public key information of the medical data browsing and updating computer 150 from the address information of the identification information of the medical data browsing and updating computer 150 and the address information of the medical institution authentication computer 160 contained in the electronic message, uses the patient's key information for decryption held in the medical data decryption computer 170 to decrypt the encrypted medical data, writes information indicating that the medical data decryption computer 170 has decrypted the encrypted medical data in response to the decryption request from the medical date browsing and updating computer 150 in the medical data, and returns the medical data to the medical data decryption computer 170 that has forwarded the request. If there is not the registered key information of the patient in that different medical data decryption computer 170, the different medical data decryption computer 170 further forwards the request to yet another medical data decryption computer 170. In order to prevent the same request from being forwarded to a medical data decryption computer 170 to which the request has been already sent, each medical data decryption computers 170 adds its identification information to the electronic message to be forwarded and does not forward the electronic message to a medical data decryption computer 170 whose identification information is written in the forwarded request electronic message.

Here, since medical data management computers 110 and the medical data management replica computers 120 may be personal computers of individuals and are not necessarily operating all the time, medical data of one patient is stored on a plurality of medical data management computers 110 and medical data management replica computers 120 in the wide-area distributed medical information network system 100. Furthermore, these computers do not necessarily need to be physically different computers. For example, a large medical institution may run the functional modules of the medical data management computer 110 and the functional modules of the medical data address management computer 130 on the same computer. However, in order to protect medical records from the risk of a disaster, these computers are preferably configured with physically different computers and distributed in locations remote from each other.

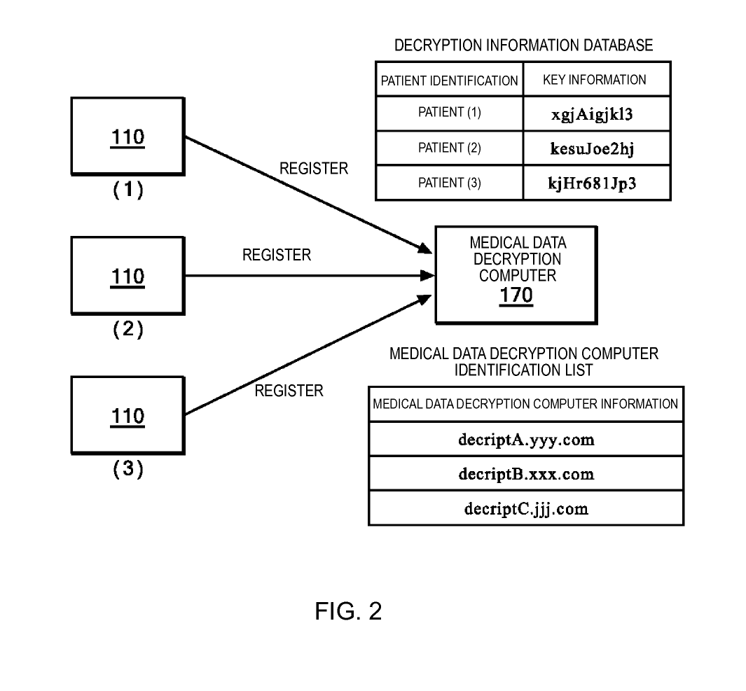

FIG. 2 schematically illustrates an example of information registered and held in a medical data decryption computer 170. Patients (1), (2) and (3) send their respective decryption information which may be key information, for example secret key information, for decrypting their respective encryption medical data in advance from their respective medical data management computers 110 (1), 110 (2) and 110 (3) to one or more medical data decryption computers 170 to register the decryption information in the medical data management computers 110. Each of the medical data decryption computers 170 stores decryption information, which may be key information, in a decryption information database in association with a patient identification which is unique information such as an IP address of a medical data management computer 110. While the key information is alphanumeric characters in the example illustrated, the key information may be other characters. Since there may be other medical data decryption computers 170 in the wide-area distributed medical information network system 100, each medical data decryption computer 170 holds information about the other medical data decryption computers 170, such as IP addresses, on a medical data decryption computer identification information list.

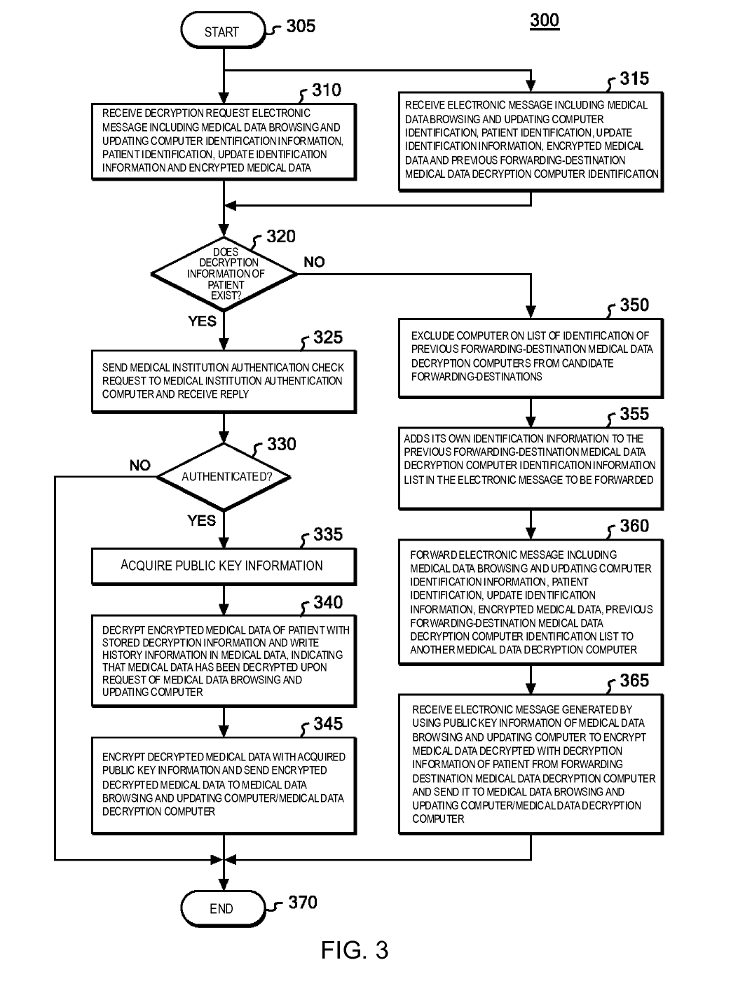

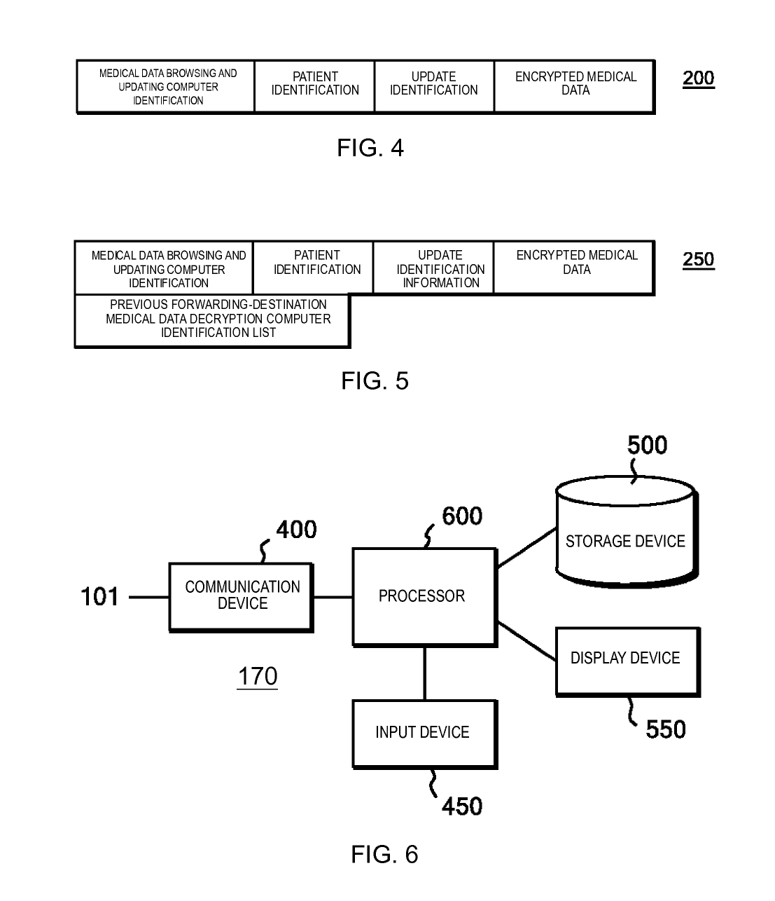

FIG. 3 illustrates a general flow 300 of a process performed by a medical data decryption computer 170. The medical data decryption computer 170 starts the process when an electronic message from a medical data browsing and updating computer 150 or another medical data decryption computer 170 is input (step 305). The medical data decryption computer 170 receives a decryption request electronic message, which is an electronic message 200 including a medical data browsing and updating computer identification information, a patient identification, an update identification information, and encrypted medical data as illustrated in FIG. 4, from a medical data browsing and updating computer 150 (step 310). Alternatively, the medical data decryption computer 170 receives an electronic message 250 including a medical data browsing and updating computer identification information, a patient identification, an update identification information, encrypted medical data, and a medical data decryption computer identification information list to which the request has been forwarded from another medical data decryption computer 170 (step 315). The medical data browsing and updating computer identification information is unique information such as an IP address of the medical data browsing and updating computer 150. The update identification information is information including, for example, an IP address of the medical data browsing and updating computer 150 and update time data. The medical data decryption computer identification information is unique information such as an IP address of the medical data decryption computer 170.

The medical data decryption computer 170 determines whether or not the patient identification included in the electronic message received from the medical data browsing and updating computer 150 or another medical data decryption computer 170 is identical to a patient identification stored in the medical data decryption computer 170 itself and therefore there is decryption information of the patient in the computer 170 itself (step 320). If there is decryption information of the patient (YES), the medical data decryption computer 170 uses the medical data browsing and updating computer identification information included in the electronic message to send an authentication check request to a medical institution authentication computer 160 and receives a reply to the authentication check request from the medical institution authentication computer 160 (step 325). The medical data decryption computer 170 determines from the received reply whether or not the medical institution identified by the medical data browsing and updating computer identification information is authenticated (step 330). If the medical institution is not authenticated (NO), the medical data decryption computer 170 ends the process without meeting the request for decryption of the encrypted medical data (step 370). If the medical institution is authenticated (YES), the reply received from the medical institution authentication computer 160 includes public key information for the medical data browsing and updating computer 150 that the medical institution has registered in the medical institution authentication computer 160 in advance, and the medical data decryption computer 170 acquires the public key information from the received reply (step 335).

The medical data decryption computer 170 decrypts the encrypted medical data of the patient with decryption information such as secret key information stored in a decryption information database and writes history information indicating that it has decrypted the encrypted medical data upon request of the medical data browsing and updating computer 150 in the medical data (step 340). The medical data decryption computer 170 encrypts the decrypted medical data with the public key information acquired from the medical institution authentication computer 160 and sends the encrypted decrypted medical data to the medical data browsing and updating computer 150 if the decryption request electronic message has been received from the medical data browsing and updating computer 150, or to a different medical data decryption computer 170 if the decryption request electronic message has been received from the different medical data decryption computer 170 (step 345), and ends the process (step 370).

Like the electronic message 250 illustrated in FIG. 5 that is forwarded from another medical data decryption computer 170, the received electronic message may include a medical data decryption computer identification information list to which the electronic has been forwarded. In that case, if it is determined at step 320 that there is not decryption information of the patient (NO), the medical data decryption computer 170 excludes the computer(s) on the medical data decryption computer identification information list to which the electronic message has been forwarded from candidate forwarding-destinations on a medical data decryption computer identification information list held in the medical data decryption computer 170 itself (step 350). This prevents the same decryption request electronic message from being forwarded to another medical data decryption computer 170 again. Like the electronic message 250 illustrated in FIG. 5 that is forwarded to another medical data decryption computer 170, the electronic message to be forwarded includes a previous forwarding-destination medical data decryption computer identification information list to which the electronic message has been forwarded. The medical data decryption computer 170 adds its own identification information to the previous forwarding-destination medical data decryption computer identification information list in the electronic message to be forwarded (step 355). This can prevent another medical data decryption computer 170 from forwarding the same decryption request electronic message to the medical data decryption computer 170 again.

The medical data decryption computer 170 forwards the electronic message including the medical data browsing and updating computer identification information, the patient identification, the update identification information, the encrypted medical data, and the previous forwarding-destination medical data decryption computer list to which the identification of the medical data decryption computer 170 itself to another medical data decryption computer that is a candidate forwarding-destination (step 360). After the forwarding, the medical data decryption computer 170 receives an electronic message generated by using the public key information of the medical data browsing and updating computer to encrypt the medical data decrypted with the decryption information of the patient. If the decryption request has been sent from the medical data browsing and updating computer 150 at step 310, the medical data decryption computer 170 sends the received electronic message to the medical data browsing and updating computer 150; if the decryption request has been sent from the different medical data decryption computer 170 at step 315, the medical data browsing and updating computer 150 sends the received electronic message to that medical data decryption computer 170 (step 365), and ends the process (step 370).

A basic hardware configuration of a medical data decryption computer 170 is schematically illustrated in FIG. 6 (with additional reference to FIG. 1). The medical data decryption computer 170 includes, a communication device 400 such as a communication adapter, for example, an input device 450 such as a keyboard and a mouse, for example, a storage device 500 such as a hard disk drive, a solid state drive and an optical drive, for example, a display device 550 such as a liquid-crystal display, for example, and a processor 600 such as a central processing unit (CPU), for example. The communication device 400 is connected to the communication network 101 and the processor 600 and is used for sending and receiving data to and from medical data management computers 110, medical data browsing and updating computers 150, medical institution authentication computers 160, and other medical data decryption computers 170. The input device 450 is connected to the processor 600 and is used for inputting information such as patients' identification information and key information when registration of decryption information is applied for in writing rather than electronically. The storage device 500 is connected to the processor 600 and is used for storing information such as patients' identification information, decryption information, and address information of medical data decryption computers 170. The display device 550 is connected to the processor 600 and is used for displaying information such as patients' identification information, decryption information, and information about authentication of medical data browsing and updating computers 150 of medical institutions. The processor 600 is used for sending and receiving data to and from these devices 400, 450, 500 and 550 and processing data and is also used for implementing the functions of decrypting encrypted medical data and encrypting decrypted medical data.

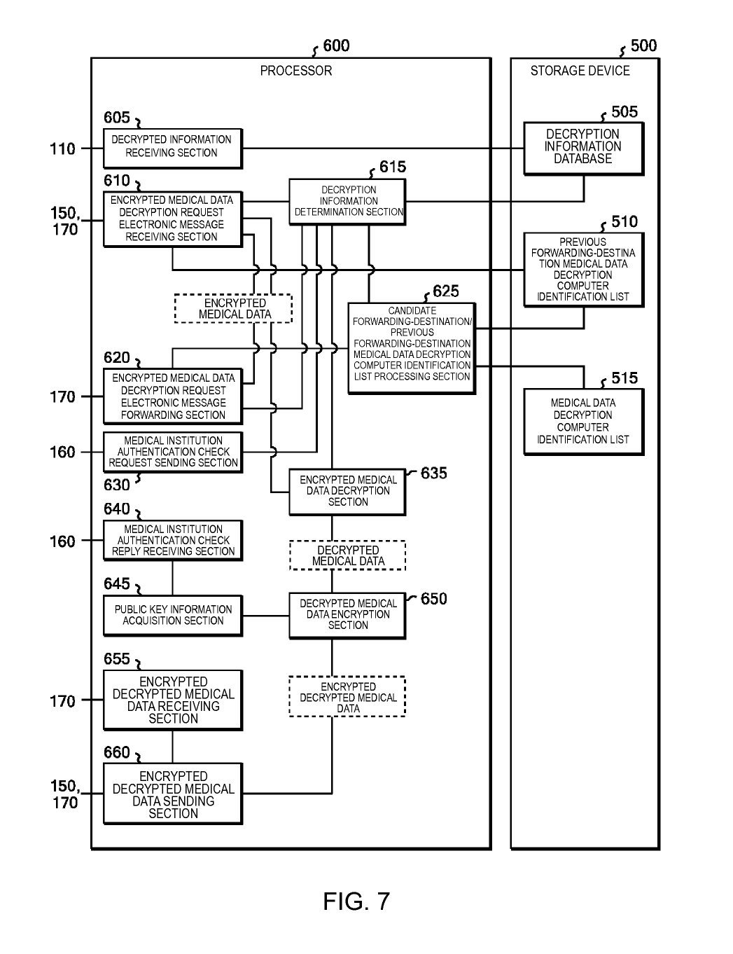

FIG. 7 illustrates a configuration used for implementing the functions of the processor 600 on the medical data decryption computer 170 to decrypt encrypted medical data and encrypt decrypted medical data. The processor 600 includes a decryption information receiving section 605, an encrypted medical data decryption request electronic message receiving section 610, a decryption information determination section 615, an encrypted medical data decryption request electronic message forwarding section 620, a candidate forwarding-destination/previous forwarding-destination medical data decryption computer identification information list processing section 625, a medical institution authentication check request sending section 630, an encrypted medical data decryption section 635, a medical institution authentication check reply receiving section 640, a public key information acquisition section 645, an decrypted medical data encryption section 650, an encrypted decrypted medical data receiving section 655, and an encrypted decrypted medical data sending section 660, all of which can be implemented by computer programs or micro codes. For this configuration of the processor 600, storage areas are provided in the storage device 500 for storing a decryption information database 505, a previous forwarding-destination medical data decryption computer identification information list 510, and a medical data decryption computer identification information list 515.

The decryption information receiving section 605 receives decryption information, which may be key information such as secret key information, for decrypting encrypted medical data to be registered in the medical data decryption computer 170 in advance from medical data management computers 110 associated with patients and provides the decryption information to the decryption information database 505, which is a storage area in the storage device 500. The decryption information database 505 stores decryption information provided from the decryption information receiving section 605. The decryption information database 505 stores the decryption information, which may be key information, in association with the patient identification, which is unique information such as an IP address of the medical data management computer 110, for example.

The encrypted medical data decryption request electronic message receiving section 610 receives an electronic message 200 including a medical data browsing and updating computer identification information, a patient identification, an update identification information and encrypted medical data as illustrated in FIG. 4 from a medical data browsing and updating computer 150 and receives an electronic message 250 including a medical data browsing and updating computer identification information, a patient identification, an update identification information, encrypted medical data, and previous forwarding-destination medical data decryption computer identification information list as illustrated in FIG. 5 from another medical data decryption computer 170. The encrypted medical data decryption request electronic message receiving section 610 provides a previous forward-destination medical data decryption computer identification information list included in an electronic message received from another medical data decryption computer 170 to a previous forwarding-destination medical data decryption computer identification information list 510, which is a storage area in the storage device 500. The previous forwarding-destination medical data decryption computer identification information list 510 stores the previous forwarding-destination medical data decryption computer identification information list provided from the encrypted medical data decryption request electronic message receiving section 610. The encrypted medical data decryption request electronic message receiving section 610 provides the encrypted medical data included in the received electronic message to the encrypted medical data decryption request electronic message forwarding section 620 and the encrypted medical data decryption section 635 as illustrated in a dashed box in FIG. 7. The encrypted medical data decryption request electronic message receiving section 610 also provides the medical data browsing and updating computer identification information, the patient identification the update identification information included in the received electronic message and, if the sender is another medical data decryption computer 170, the originating medical data decryption computer identification information in the electronic message, to the decryption information determination section 615.

The decryption information determination section 615 is provided with a patient identification from the encrypted medical data decryption request electronic message receiving section 610 and determines whether or not the patient identification is identical to a patient identification stored in the decryption information database 505 and therefore decryption information of the patient is in the decryption information database 505. The decryption information determination section 615 is configured, for example, to search the decryption information database 505 for a patient identification entry that matches the provided patient identification and detect whether or not the matching patient identification entry contains decryption information. If the decryption information determination section 615 determines that there is not decryption information of the patient, the decryption information determination section 615 provides the medical data browsing and updating computer identification information, the patient identification and the update identification information provided from the encrypted medical data decryption request electronic message receiving section 610 to the encrypted medical data decryption request electronic message forwarding section 620 and instructs the candidate forwarding-destination/previous forwarding-destination medical data decryption computer identification information list processing section 625 to process a candidate forwarding-destination and previous forwarding-destination medical data decryption computers. If the decryption information determination section 615 determines that there is decryption information of the patient, the decryption information determination section 615 provides the decryption information of the patient provided from the decryption information database 505 and medical data browsing and updating computer identification information or the originating medical data decryption computer identification information, the patient identification and the update identification information provided from the encryption data decryption request electronic message receiving section 610 to the encrypted medical data decryption section 635 and also provides the medical data browsing and updating computer identification information to the medical institution authentication check request sending section 630.

The encrypted medical data decryption request electronic message forwarding section 620 is provided with a medical data browsing and updating computer identification information, a patient identification and an update identification information from the decryption information determination section 615 and uses, in combination with these items of information, encrypted medical data provided from the decryption information determination section 615, and a previous forwarding-destination medical data decryption computer identification information list provided from the candidate forwarding-destination/previous forwarding-destination medical data decryption computer identification information list processing section 625 to generate an electronic message 250 including the medical data browsing and updating computer identification, the patient identification, the update identification information, the encrypted medical data, and the previous forwarding-destination medical data decryption computer identification information list as illustrated in FIG. 5 and forwards the electronic message 250 to another medical data decryption computer 170 selected from candidate forwarding destinations provided from the candidate forwarding-destination/previous forwarding-destination medical data decryption computer identification information list processing section 625.

The candidate forwarding-destination/previous forwarding-destination medical data decryption computer identification information list processing section 625 is instructed by the decryption information determination section 615 to process a candidate forwarding-destination and previous forwarding-destination medical data decryption computer list. If the previous forwarding-destination medical data decryption computer identification information list is stored in the previous forwarding-destination medical data decryption computer identification information list 510, the candidate forwarding-destination/previous forwarding-destination medical data decryption computer identification information list processing section 625 acquires the list from the previous forwarding-destination medical data decryption computer identification information list 510 and retrieves a medical data decryption computer identification information list from the medical data decryption computer identification information list 515, which is a storage area in the storage device 500. If the candidate forwarding-destination/previous forwarding-destination medical data decryption computer identification information list processing section 625 has acquired the previous forwarding-destination medical data decryption computer identification information list, the candidate forwarding-destination/previous forwarding-destination medical data decryption computer identification information list processing section 625 excludes the computer(s) on the previous forwarding-destination medical data decryption computer identification information list from candidate forwarding destinations on the acquired medical data decryption computer identification information list and provides the resulting candidate forwarding destinations to the encrypted medical data decryption request electronic message forwarding section 620. If candidate forwarding-destination/previous forwarding-destination medical data decryption computer identification information list processing section 625 has acquired the previous forwarding-destination medical data decryption computer identification information list from the previous forwarding-destination medical data decryption computer identification information list 510, the candidate forwarding-destination/previous forwarding-destination medical data decryption computer identification information list processing section 625 adds the identification information of the own medical data decryption computer to the acquired previous forwarding-destination medical data decryption computer identification information list and provides the resulting previous forwarding-destination medical data decryption computer identification information list to the encrypted medical data decryption request electronic message forwarding section 620. If the candidate forwarding-destination/previous forwarding-destination medical data decryption computer identification information list processing section 625 has not acquired a previous forwarding-destination medical data decryption computer identification information list from the previous forwarding-destination medical data decryption computer identification information list 510, the candidate forwarding-destination/previous forwarding-destination medical data decryption computer identification information list processing section 625 generates a medical data decryption computer identification information list including the identification information of the own medical data decryption computer and provides the generated medical data decryption computer identification information list to the encrypted medical data decryption request electronic message forwarding section 620.

The medical institution authentication check request sending section 630 is provided with a medical data browsing and updating identification information from the decryption information determination section 615 and uses the medical data browsing and updating computer identification information to send a request for checking authentication of a medical institution to a medical institution authentication computer 160. The medical institution authentication computer 160 receives the request for checking authentication of the medical institution and, if that medical institution is registered, returns registered public key information.

The encrypted medical data decryption section 635 is provided with decryption information of a patient from the decryption information determination section 615, uses the decryption information to decrypt encrypted medical data provided from the encrypted medical data decryption request electronic message receiving section 610, and writes history information in the medical data, indicating that the encrypted medical data has been decrypted in response to a request from the medical data browsing and updating computer 150. The encrypted medical data decryption section 635 provides the decrypted medical data to the decrypted medical data encryption section 650 together with a medical data browsing and updating computer identification information or an originating medical data decryption computer identification information, a patient identification, and an update identification information provided from the decryption information determination section 615, as illustrated in dashed box in FIG. 7.

The medical institution authentication check reply receiving section 640 receives a medical institution authentication check reply to a medical institution authentication check request from a medical institution authentication computer 160 and provides the reply to the public key information acquisition section 645. If the medical institution is authenticated, the medical institution authentication check reply includes registered public key information, and the public key information acquisition section 645 acquires the public key information from the medical institution authentication reply and provides the public key information to the decrypted medical data encryption section 650. If the medical institution is not authenticated, the medical institution authentication check reply does not include registered public key information. Accordingly, the public key information acquisition section 645 does not provide public key information to the decrypted medical data encryption section 650. If the medical institution is not authenticated, the processor 600 does not process the encrypted medical data decryption request.

When the decrypted medical data encryption section 650 is provided with public key information from the public key information acquisition section 645, the decrypted medical data encryption section 650 encrypts decrypted medical data provided from the encrypted medical data decryption section 635 with the public key information. As illustrated in a dashed box in FIG. 7, the decrypted medical data encryption section 650 provides the medical data that has been decrypted and then encrypted (encrypted decrypted medical data) to the encrypted decrypted medical data sending section 660 together with a medical data browsing and updating computer identification information or an originating medical data decryption computer identification information, a patient identification, and an update identification information provided from the encrypted medical data decryption section 635.

The encrypted decrypted medical data receiving section 655 receives a reply from a different medical data decryption computer 170 to an encrypted medical data decryption request forwarded from the encrypted medical data decryption request electronic message forwarding section 620 to the different medical data decryption computer 170, that is, an electronic message which includes encrypted decrypted medical data if the encrypted medical data has been successfully decrypted by the different medical data decryption computer 170, and provides the reply to the encrypted decrypted medical data sending section 660. If the different medical data decryption computer 170 has failed to decrypt the encrypted medical data, the encrypted decrypted medical data receiving section 655 does not receive a reply from the medical data decryption computer 170 and therefore notifies the encrypted decrypted medical data sending section 660 that no reply has been received, and the processor 600 does not process the encrypted medical data decryption request.

When the encrypted decrypted medical data sending section 660 is provided with an electronic message including encrypted decrypted medical data from the encrypted decrypted medical data receiving section 655, the encrypted decrypted medical data sending section 660 sends the electronic message to a computer identified by a medical data browsing and updating computer identification information or an originating medical data decryption computer identification information provided from the decrypted medical data encryption section 650. When the encrypted decrypted medical data sending section 660 is provided with encrypted decrypted medical data from the decrypted medical data encryption section 650 together with a medical data browsing and updating computer identification information or an originating medical data decryption computer identification information, a patient identification and an update identification information, the encrypted decrypted medical data sending section 660 sends an electronic message including the patient identification, the update identification information and the encrypted decrypted medical data to a computer identified by the medical data browsing and updating computer identification information or the originating medical data decryption computer identification information.

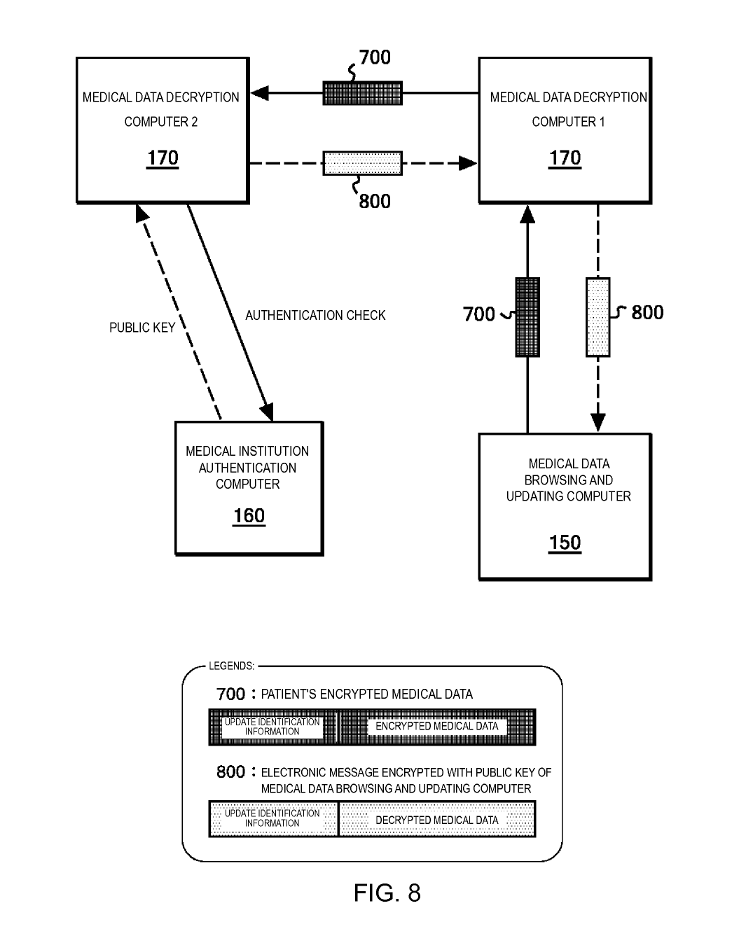

FIG. 8 schematically illustrates an example of data flow when encrypted medical data is decrypted on the communication network. In the event of an emergency where encrypted medical data of a patient has been successfully acquired from a medical data management computer 110 on the communication network but decryption information for decrypting the encrypted medical data cannot be acquired from the patient, the medical data browsing and updating computer 150 sends an encrypted medical data decryption request electronic message 700 including the encrypted medical data of the patient to a medical data decryption computer 1 (170). Upon receiving the electronic message 700, the medical data decryption computer 1 starts processing the electronic message 700. The medical data decryption computer 1 does not hold the decryption information of the patient and therefore forwards the electronic message 700 to another medical data decryption computer 2 (170). Upon receiving the electronic message 700, the medical data decryption computer 2 starts processing of the electronic message 700. The medical data decryption computer 2 holds the decryption information of the patient and therefore requests the medical institution authentication computer 160 to check whether the medical institution that owns the medical data browsing and updating computer 150 is authenticated and, if the medical institution is authenticated and registered in the medical institution authentication computer 160, acquires public key information of the medical institution from the medical institution authentication computer 160. The medical data decryption computer 2 decrypts the encrypted medical data with decryption information it holds to generate decrypted medical data, encrypts the decrypted medical data with the acquired public key information to generate an electronic message 800 including the encrypted decrypted medical data, and sends the electronic message 800 to the medical data decryption computer 1. Upon receiving the electronic message 800, the medical data decryption computer 1 starts processing the electronic message 800. Specifically, the medical data decryption computer 1 sends the electronic message 800 to the medical data browsing and updating computer 150. The medical data browsing and updating computer 150 receives the electronic message 800 and uses secret key information corresponding to the public key information to decrypt the decrypted medical data encrypted with the public key information for browsing and updating the decrypted medical data. In this way, medical information is securely and reliably provided to the medical data browsing and updating computer 150.

Standardization of the data formats of electronic medical records is being facilitated and the foundation to enable sharing electronic medical records is being laid. From a practical point of view, however, sharing of electronic records has not been widespread. This is because building a system that manages electronic medical records costs a large amount of money. For example, the following “three criteria for electronic medical records” are required to be met for sharing electronic medical records.

### 1. Authenticity

Intentional or accidental input of false data and intentional or accidental alteration, deletion, or confusion of data should be prevented.
Where the responsibility for making medical records lies should be clarified.
   2. Visual readability
Data should be readily made readable to the naked eye as needed.
Data should be able to be immediately presented on paper as needed.

### 3. Storability

Data should be stored for a legally-defined period of time in such a way that the data can be restored.

Criteria 3 (Storability) requires building of a robust database, resulting in a high system cost. Consequently, only well-financed medical institutions have introduced electronic medical record systems.

Another problem is that patients' electronic medical records can be lost in the event of a disaster at medical institutions having electronic medical record system. To prepare for such a disaster, a replica of an electronic medical record database needs to be maintained in a remote location. However, most medical institutions are community-based institutions and it is difficult for such medical institutions to maintain a replica database in a location remote from the medical institutions.

Another patent application previously filed by the inventors has proposed a data management mechanism for implementing a “medical information network” that enables distributed management of medical information across various computers on a communication network, instead of a particular medical institution holding an expensive electronic medical records system and managing electronic medical records. In the data management mechanism, medical data of a patient is encrypted and, in order to decrypt the data, decryption information, for example key information such as a secret key for decrypting the patient’ medical data is required. In the event of an emergency where the patient is brought into an emergency medical facility due to an accident or a seizure, however, the emergency medical facility cannot access the medical data of the patient because the medical facility is unable to acquire the key information of the patient.

One known prior art describes a medical information query system that includes a registration and update server and a medical information server. In the system, a user uses a personal ID (identification information) and a password to register and store medical information in a medical information DB (database) on the medical information server through the registration and update server in advance and carries along an emergency card, which is query password bearing means and, if the user receives an emergency case at a registered hospital, the registered hospital uses the personal ID and the query password written on the emergency card to access the medical information server, thereby retrieving the user's medical information stored in the medical information DB for use in the emergency case. The medical information query system is capable of responding to an emergency for a user. However, since the medical information is centrally stored and managed in the medical information DB on the medical information server and each user needs to carry along all times an emergency card bearing his/her personal ID and query password, there is the risk of loss and theft of the emergency card and carrying along the emergency card all times is by no means safe.

Another known prior art describes a system in which at least minimum data required for diagnosis and treatment among patient data is forwarded to and registered in a medical information central processing center communication device in advance with patients' consent so that, in the event of an emergency for a patient where it is difficult to obtain permission from the patient, another medical institution communication device can request the medical information central processing center communication device to forward data of the patient and the medical institution communication device can refer to the minimum data forwarded in response to the request. While the medical information providing and acquiring system is capable of responding to an emergency, centrally storing and managing medical information on a single location such as the central processing center costs a large amount of money and requires security measures for management of the information and safety measures for a natural disaster. In addition, the system has to limit the medical information to minimum data and sufficient medical information cannot be fully used.

Another known prior art discloses a system in which a user authentication server manages user attribute information and provides user attribute information to a cooperative service server together with a result of authentication in response to a user authentication request from the cooperative service server, the service cooperative server sends a user reference request including user attribute information to a data server, and the data server controls disclosure of personal data on the basis of the user attribute information included in the request, thereby maintaining a high level of security of management of user attributes and improving the reliability of access to personal data that uses user attribute information. While the distributed information access system improve the reliability of access to personal data that uses attribute information by managing the user attribute information on the user authentication server, the system only identifies and authenticate users to manage personal data of the users and does not encrypt the users' personal data with information owned by the users' personal data. The system cannot respond to an emergency where information owned by the user cannot be obtained and centrally storing and managing personal data on a data server costs a large amount of money and requires security measures for management of the information and safety measures for a natural disaster.

Thus, one object of the present invention disclosed herein is to implement a “medical information network” that can distribute and manage medical information across various computers on a communication network and can securely and reliably provide medical information in the event of an emergency. Objects of the present invention include providing a method, system and computer program that build a data management mechanism for implementing such a “medical information network” for securely and reliably providing medical information in the event of an emergency.

In one embodiment of the present invention, a method for provides medical information on a communication network according to one embodiment of the present invention includes the steps of receiving encrypted medical information in a decryption request from a first computer connected to the communication network at a second computer which is connected to the communication network and holds decryption information, determining at the second computer whether or not the second computer holds decryption information for decrypting the encrypted medical information, when the second computer holds the decryption information, checking by the second computer with a third computer, which is connected to the communication network and performs authentication of the first computer and registration of encryption information for the first computer, whether the first computer is authenticated, and when the first computer is authenticated, acquiring by the second computer the encryption information for the first computer from the third computer, decrypting the encrypted medical information by using the decryption information, encrypting the decrypted medical information by using the encryption information and sending the encrypted decrypted medical information to a sender that has sent the encrypted medical information.

In one embodiment of the present invention, the method further includes the step of, when the second computer does not hold the decryption information, forwarding the encrypted medical information from the second computer to another second computer connected to the communication network.

In one embodiment of the present invention, the method further includes the step of registering decryption information provided from a person concerning medical information in association with identification information of the person.

In one embodiment of the present invention, the step of receiving includes the step of receiving at least identification information of the first computer and identification information of the person concerning the medical information among the identification information of the first computer, the identification information of the person, and identification information of a previous forwarding-destination second computer that has already received the encrypted medical information.

In one embodiment of the present invention, the step of determining includes the step of detecting whether or not the received identification information of the person is identical to identification information of the person that is held in the second computer.

In one embodiment of the present invention, the step of checking includes the step of sending the received identification information of the first computer to the third computer.

In one embodiment of the present invention, the step of forwarding includes the step of excluding the second computer identified by the received identification information of the previous forwarding-destination second computer from candidate forwarding-destinations.

In one embodiment of the present invention, the step of forwarding includes the step of forwarding the second computer's own identification information in addition to the received identification information of the previous forwarding-destination second computer to another second computer.

In one embodiment of the present invention, the method further includes the step of receiving encrypted decrypted medical information from another second computer to which the information has been forwarded and sending the encrypted decrypted medical information to the sender that has sent the encrypted medical information.

In one embodiment of the present invention, the first computer is a medical data browsing and updating computer, the second computers are medical data decryption computers, and the third computer is a medical institution authentication computer.

In one embodiment of the present invention, a computer program provides medical information on a communication network causes a second computer to execute the steps of the above-described method performed by the second computer.

In one embodiment of the present invention, a system provides medical information on a communication network that includes a first computer being connected to the communication network and issuing a request for decrypting encrypted medical information, a third computer being connected to the communication network and performing authentication of the first computer and registration of encryption information for the first computer, and a second computer connected to the communication network which includes a decryption information holding section holding decryption information, a receiving section for receiving encrypted medical information in a decryption request from the first computer, a determination section for determining whether or not decryption information for decrypting the encrypted medical information is held in the decryption information holding section, an authentication check section for, when the determination section determines that the decryption information is held, checking with the third computer whether or not the first computer is authenticated and, when the first computer is authenticated, acquiring the encryption information for the first computer from the third computer, a decryption section for decrypting the encrypted medical information by using the decryption information held in the decryption information holding section, an encryption section for using the encryption information acquired by the authentication check section to encrypt the medical information decrypted by the decryption section, and a sending section for sending the decrypted medical information encrypted by the encryption section to a sender that has sent the encrypted medical information.

In one embodiment of the present invention, the second computer further includes a forwarding section for forwarding the encrypted medical information to another second computer connected to the communication network when the determination section determines that the decryption information is not held.

In one embodiment of the present invention, the decryption information holding section registers decryption information provided from a person concerning the medical information in association with identification information of the person.

In one embodiment of the present invention, the receiving section receives at least identification information of the first computer and identification information of the person concerning the medical information among the identification information of the first computer, the identification information of the person, and identification information of a previous forwarding-destination second computer that has already received the encrypted medical information.

In one embodiment of the present invention, the determination section detects whether or not the received identification information of the person is identical to identification information of the person that is held in the second computer.

In one embodiment of the present invention, the authentication check section sending the received identification information of the first computer to the third computer.

In one embodiment of the present invention, the forwarding section excludes the second computer identified by the received identification information of the previous forwarding-destination second computer from candidate forwarding-destinations.

In one embodiment of the present invention, the forwarding section forwards the second computer's own identification information in addition to the received identification information of the previous forwarding-destination second computer to another second computer.

In one embodiment of the present invention, the second computer further comprises a receiving section for receiving encrypted decrypted medical information from another second computer to which the information has been forwarded and the sending section sends the received encrypted decrypted medical information to the sender that has sent the encrypted medical information.

In one embodiment of the present invention, the first computer is a medical data browsing and updating computer, the second computers are medical data decryption computers, and the third computer is a medical institution authentication computer.

Thus, as described herein and according to one or more embodiments, the present invention implements a “medical information network” that enables distributed management of medical information across various computers on a communication network and is capable of providing medical information securely and reliably in the event of an emergency. In particular, the present invention provides a method, system and computer program that build a data management mechanism for implementing such a “medical information network” for securely and reliably providing medical information in the event of an emergency. According to the present invention, encrypted medical data can be securely and reliably provided through a communication network and even a medical institution that does not have an expensive database system can ensure authenticity, visual readability and storability on a small system (for example, an application running on personal computers PC) to handle electronic medical records.

While the present invention has been described with an embodiment thereof, the technical scope of the present invention is not limited to the scope described with respect to the embodiment. Various modifications or improvements can be made to the embodiment and it will be understood that such modified or improved embodiment are included in the technical scope of the present invention.

What is claimed is:

1. A method for providing medical information on a communication network, the method comprising:
receiving encrypted medical information in a decryption request from a first computer connected to the communication network at a second computer, the second computer being connected to the communication network and holding decryption information;
determining at the second computer whether or not the second computer holds decryption information for decrypting the encrypted medical information;
in response to the second computer determining that the second computer holds the decryption information, checking by the second computer with a third computer whether the first computer is authenticated, the third computer being connected to the communication network and performing authentication of the first computer and registration of encryption information for the first computer; and
in response to the first computer being authenticated, the second computer:
acquiring the encryption information for the first computer from the third computer;
decrypting the encrypted medical information by using the decryption information to create decrypted medical information;
encrypting the decrypted medical information by using the encryption information to create encrypted decrypted medical information; and
sending the encrypted decrypted medical information to a sender that has sent the encrypted medical information.

2. The method according to claim 1, further comprising:
in response to the second computer determining that the second computer does not hold the decryption information, forwarding the encrypted medical information from the second computer to another second computer connected to the communication network.

3. The method according to claim 1, further comprising:
registering, by the second computer, decryption information, provided from a person concerning medical information, in association with identification information of the person.

4. The method according to claim 3, further comprising:
receiving, by the second computer, identification information of the first computer, the identification information of the person, and identification information of a previous forwarding-destination second computer that has already received the encrypted medical information.

5. The method according to claim 4, further comprising:
detecting whether or not the received identification information of the person is identical to identification information of the person that is held in the second computer.

6. The method according to claim 4, further comprising:
sending the received identification information of the first computer to the third computer.

7. The method according to claim 4, further comprising:
excluding the second computer identified by the received identification information of the previous forwarding-destination second computer from candidate forwarding-destinations.

8. The method according to claim 4, further comprising:
forwarding the second computer's own identification information in addition to the received identification information of the previous forwarding-destination second computer to the another second computer.

9. The method according to claim 2, further comprising:
receiving encrypted decrypted medical information from the another second computer to which the information has been forwarded and sending the encrypted decrypted medical information to the sender that has sent the encrypted medical information.

10. The method according to claim 1, wherein the first computer is a medical data browsing and updating computer, the second computers are medical data decryption computers, and the third computer is a medical institution authentication computer.

11. A computer program product for providing medical information on a communication network, the computer program product comprising a computer readable storage medium having program code embodied therewith, the program code readable and executable by a processor to perform a method comprising:
receiving encrypted medical information in a decryption request from a first computer connected to the communication network at a second computer, the second computer being connected to the communication network and holding decryption information;
determining at the second computer whether or not the second computer holds decryption information for decrypting the encrypted medical information;
in response to the second computer determining that the second computer holds the decryption information, checking by the second computer with a third computer whether the first computer is authenticated, the third computer being connected to the communication network and performing authentication of the first computer and registration of encryption information for the first computer; and
in response to the first computer being authenticated, the second computer:
acquiring the encryption information for the first computer from the third computer;
decrypting the encrypted medical information by using the decryption information to create decrypted medical information;
encrypting the decrypted medical information by using the encryption information to create encrypted decrypted medical information; and
sending the encrypted decrypted medical information to a sender that has sent the encrypted medical information.

12. A system for providing medical information on a communication network, the system comprising:
a first computer being connected to the communication network and issuing a request for decrypting encrypted medical information;
a third computer being connected to the communication network and performing authentication of the first computer and registration of encryption information for the first computer; and
a second computer connected to the communication network, the second computer comprising:
a decryption information holding section holding decryption information;
a receiving section for receiving encrypted medical information in a decryption request from the first computer;
a determination section for determining whether or not decryption information for decrypting the encrypted medical information is held in the decryption information holding section;
an authentication check section for, when the determination section determines that the decryption information is held, checking with the third computer whether or not the first computer is authenticated and, when the first computer is authenticated, acquiring the encryption information for the first computer from the third computer;
a decryption section for decrypting the encrypted medical information by using the decryption information held in the decryption information holding section;
an encryption section for using the encryption information acquired by the authentication check section to encrypt the medical information decrypted by the decryption section; and
a sending section for sending the decrypted medical information encrypted by the encryption section to a sender that has sent the encrypted medical information.

13. The system according to claim 12, wherein the second computer further comprises a forwarding section for forwarding the encrypted medical information to another second computer connected to the communication network when the determination section determines that the decryption information is not held.

14. The system according to claim 12, wherein the decryption information holding section registers decryption information provided from a person concerning the medical information in association with identification information of the person.

15. The system according to claim 14, wherein the receiving section receives at least identification information of the first computer and identification information of the person concerning the medical information among the identification information of the first computer, the identification information of the person, and identification information of a previous forwarding-destination second computer that has already received the encrypted medical information.

16. The system according to claim 15, wherein the determination section detects whether or not the received identification information of the person is identical to identification information of the person that is held in the second computer.

17. The system according to claim 15, wherein the authentication check section sends the received identification of the first computer to the third computer.

18. The system according to claim 15, wherein the forwarding section excludes the second computer identified by the received identification information of the previous forwarding-destination second computer from candidate forwarding-destinations.

19. The system according to claim 15, wherein the forwarding section forwards the second computer's own identification in addition to the received identification of the previous forwarding-destination second computer to the another second computer.

20. The system according to claim 13, wherein the second computer further comprises a receiving section for receiving encrypted decrypted medical information from the another second computer to which the information has been forwarded and the sending section sends the received encrypted decrypted medical information to the sender that has sent the encrypted medical information.
